(19) United States
(12) Patent Application Publication
(10) Pub. No.: US 2023/0103360 A1
(43) Pub. Date: Apr. 6, 2023

(54) SYSTEMS AND METHODS FOR IMPROVED AGENT-CONSUMER COMMUNICATION AND INSURANCE ENROLLMENT

(71) Applicant: Integrity Marketing Group, LLC, Dallas, TX (US)

(72) Inventors: Harsh Singla, Dallas, TX (US); Jake Christensen, Dallas, TX (US); Eric Wade, Dallas, TX (US)

(21) Appl. No.: 17/667,125

(22) Filed: Feb. 8, 2022

Related U.S. Application Data
(60) Provisional application No. 63/251,481, filed on Oct. 1, 2021.

(51) Int. Cl. G06Q 40/08; G06F 3/0482; G06F 3/04847; G06Q 10/10

(52) U.S. Cl. CPC G06Q 40/08; G06F 3/0482; G06F 3/04847; G06Q 10/1095

(57) ABSTRACT

This document describes techniques, methods, systems, and other mechanisms for improving interactions between insurance agents, insurance providers, and insurance customers while ensuring that such interactions comply with regulatory requirements. This includes providing unique user interfaces that facilitate efficient communication between computing devices operated by insurance agents and computing devices operated by insurance customers to ensure that electronic scope of appointment forms are provided to potential customers and executed in accordance with government regulations prior to face to face or telephonic meetings between an insurance agent and an insurance customer.

### CROSS-REFERENCE TO RELATED APPLICATION(S)

This application claims priority to U.S. Provisional Application Ser. No. 63/251,481 filed on Oct. 1, 2021 and entitled “SYSTEMS AND METHODS FOR IMPROVED AGENT-CONSUMER COMMUNICATION AND INSURANCE ENROLLMENT,” the contents of which are incorporated herein by reference in their entirety.

### TECHNICAL FIELD

This document describes computer systems, user interfaces, and computer-implemented methods for providing improved relationship management between, for example, insurance providers, agents, and consumers. In particular embodiments, the computer systems, user interfaces, and computer-implemented methods can achieve improved interactions between insurance agents, insurance providers, and insurance customers while ensuring that such interactions comply with regulatory requirements.

### BACKGROUND

When interacting with potential customers regarding available insurance coverage plans, an insurance agent is often faced with a complex set of options, prices, and limits for communicating to such customers. Further, agents may often document their meetings with potential and current beneficiaries for purposes of ensuring compliance with regulations or other obligations. In some cases a “scope of appointment” form may help to focus the consultation and allow the agent to prepare material for the consultation that can help consumers better understand their insurance coverage options.

### SUMMARY

This document describes techniques, methods, systems, and other mechanisms for improving interactions between insurance agents, insurance providers, and insurance customers while ensuring that such interactions comply with regulatory requirements. This includes providing unique user interfaces that facilitate efficient communication between computing devices operated by insurance agents and computing devices operated by insurance customers to ensure that electronic scope of appointment forms are provided to potential customers and executed in accordance with government regulations prior to face to face or telephonic meetings between an insurance agent and an insurance customer.

When interacting with potential customers regarding specific types of available insurance coverage plans, an insurance agent is generally required to obtain a signed scope of appointment (SOA) form from the potential customer that identifies the specific type or types of insurance plans to be discussed. This form lets the agent know beforehand which coverage options are open for discussion. The purpose of an electronic SOA form is to determine which plans to discuss. (Thus, as used herein, the term “electronic scope of appointment form” (or “electronic SOA form”) refers to a predefined electronic form that identifies a limitation upon the range of insurance products to be discussed between an insurance agent and an insurance customer so that no other types of products are intended to be discussed outside of those the insurance customer previously requested or otherwise identified.) Among other benefits, the presently described computing systems, user interfaces, and methods provide a more intuitive experience for insurance customers that allow them to better understand the options listed in an electronic SOA form, which allows such customers to be better informed with respect to the pre-designated scope of appointment that they have selected, which can protect consumers from high-pressure salespeople. In these embodiments, the systems and method described herein can advantageously interface with agents to highlight that they are prohibited from discussing non-selected coverage options without first obtaining a new scope of appointment. The presently described computing systems, user interfaces, and methods provide a user-friendly mechanism for allowing insurance agents to manage SOAs for numerous clients, including multiple SOAs for each individual client, such that the clients can be provided with various insurance options while still keeping with applicable regulations. Thus, the below described systems for managing interactions between insurance agents and customers, including systems for generating, managing, and tracking various SOAs (as defined by executed electronic SOA forms) function to protect both the consumer and the agent.

In particular implementations detailed below, a properly executed electronic SOA form allows the agent to show that the consumer understood which specific coverage options were up for discussion during an insurance consultation. Examples of coverage options that can be selected in an electronic SOA form include stand-alone Medicare Prescription Drug Plans (Part D), Medicare Advantage Plans (Part C) and Cost Plans, Medicare Supplements (Medigap) Products, DentalNision/Hearing Products plans, and Hospital Indemnity Products. The systems described below can also assist insurance agents with documenting their meetings and other interactions with potential and current beneficiaries. In these embodiments, a properly executed electronic SOA form also be used by the system to automatically identify and prepare material for the consultation between the insurance agent and the insurance customer that can help the insurance customer better understand their insurance coverage options.

In general, methods, computing systems, and computer readable instructions cause one or more computing apparatus to perform functions including: receiving, by a computing system, information for an insurance product customer, the information including a preferred contact method for the insurance product customer; generating, by the computing system, a client profile for the insurance product customer; setting a status for the client profile and associating the status with the client profile; transmitting, by the computing system over a network to a first remote computing device, client profile user interface information that, when rendered by the first remote computing device causes the first remote computing device to display a first user interface, the first user interface including: (i) an indication of the preferred contact method for the insurance product customer; (ii) a first user-selectable control for setting one or more reminders in association with the insurance product customer; and (iii) a second user-selectable control that, when selected, causes the first remote computing device to display information related to an electronic scope of appointment form for the insurance product customer; receiving, by the computing system from the first remote computing device, an indication that a user of the first remote computing device has provided user input indicating an intention to generate and transmit the electronic scope of appointment form for the insurance product customer; in response to receiving the indication that the user of the first remote computing device has provided the user input indicating an intention to generate and transmit the electronic scope of appointment form for the insurance product customer, transmitting, by the computing system over the network to the first remote computing device, second user interface information that, when rendered by the first remote computing device causes the first remote computing device to display a second user interface, the second user interface including: (i) a third user-selectable control that allows the user to select a contact method transmitting the electronic scope of appointment form to the insurance product customer; and (ii) a fourth user-selectable control for initiating generation and transmission of the electronic scope of appointment form for the insurance product customer; receiving, by the computing system from the first remote computing device, an indication of a contact method indicated by the third user-selectable control and an indication that the user of the first remote computing device has selected the fourth user-selectable control; in response to receiving the indication that the user of the first remote computing device has selected the fourth user-selectable control: (i) generating, by the computing system, the electronic scope of appointment form for the insurance product customer including automatically populating the electronic scope of appointment form with a name of the insurance product customer; and (ii) transmitting, by the computing system, a communication to a second remote computing device; wherein the electronic scope of appointment form includes a plurality of coverage options selectable by the insurance product customer, the communication to the second remote computing device includes a link to the electronic scope of appointment form, and the communication is transmitted to the contact method indicated by the third user-selectable control; in response to transmitting the communication, updating, by the computing system, the status for the client profile to a scope of appointment form sent status; receiving, by the computing system, an indication that the insurance product customer has selected one or more of the plurality of coverage options included in the electronic scope of appointment form and an indication that the insurance product customer has electronically signed the electronic scope of appointment form; in response to receiving the indication that the insurance product customer has signed the electronic scope of appointment form, updating, by the computing system, the status for the client profile to a scope of appointment form signed status; and transmitting, by the computing system over the network to the first remote computing device, third user interface information that, when rendered by the first remote computing device causes the first remote computing device to display a third user interface, the third user interface including the updated status for the client profile indicating the scope of appointment form signed status for the client profile.

Particular implementations can, in certain instances, realize one or more of the following advantages. The streamlined and efficient user interfaces described herein allow for agents and insurance customers to easily navigate a complex and confusing system, thereby improving the user experience and reducing the amount of time that both agents and insurance customers need to interact with the automated system. This reduction in time spent navigating the automated system reduces power consumption and communication bandwidth as the improved insurance quote and enrollment facilitation system described herein reduces the amount of communication needed and the time spent by users with respect to traditional systems. The system also ensures that insurance quote and enrollment processes are performed in accordance with relevant regulations to facilitate a smooth user experience for both agents and insurance customers.

The details of one or more implementations are set forth in the accompanying drawings and the description below. Other features, objects, and advantages will be apparent from the description and drawings, and from the claims.

### DESCRIPTION OF DRAWINGS

FIG. 1A shows an example computing system for facilitating compliant insurance enrollment.

FIG. 1B shows an example user interface displaying contacts in a card view.

FIG. 1C shows an example user interface displaying contacts in a list view.

FIG. 2 shows an example user interface for adding a new contact to a list of contacts for an insurance agent.

FIGS. 3A-3B show an example profile for a client contact.

FIG. 4 shows an example user interface for generating and sending an electronic scope of appointment form to a client contact.

FIG. 5 shows an example user interface providing contact details for a client contact.

FIGS. 6a -6E show example user interfaces for providing additional details for a client contact for automatically identifying relevant insurance plans.

FIG. 7 shows an example user interface displaying automatically identified insurance plan options for a client.

FIG. 8 shows an user interface including an automatically generated activity list for an insurance agent.

FIG. 9 is a block diagram of computing devices that may be used to implement the systems and methods described in this document, as either a client or as a server or plurality of servers.

Like reference symbols in the various drawings indicate like elements.

### DETAILED DESCRIPTION

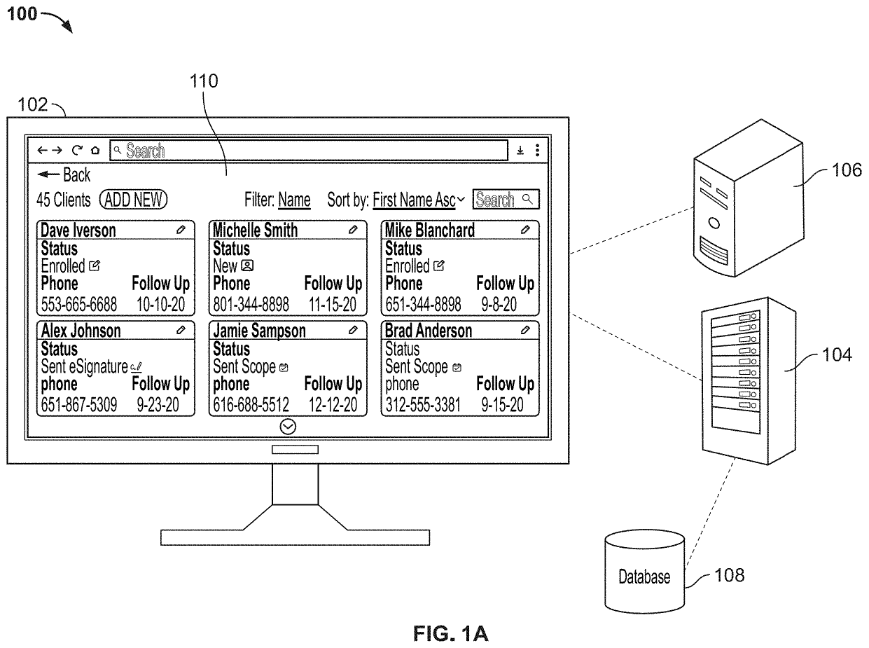

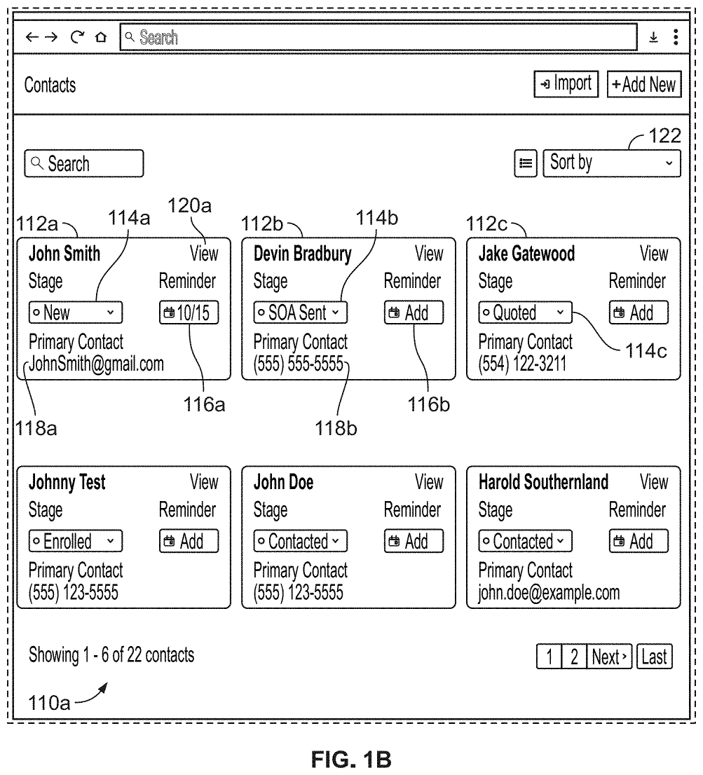

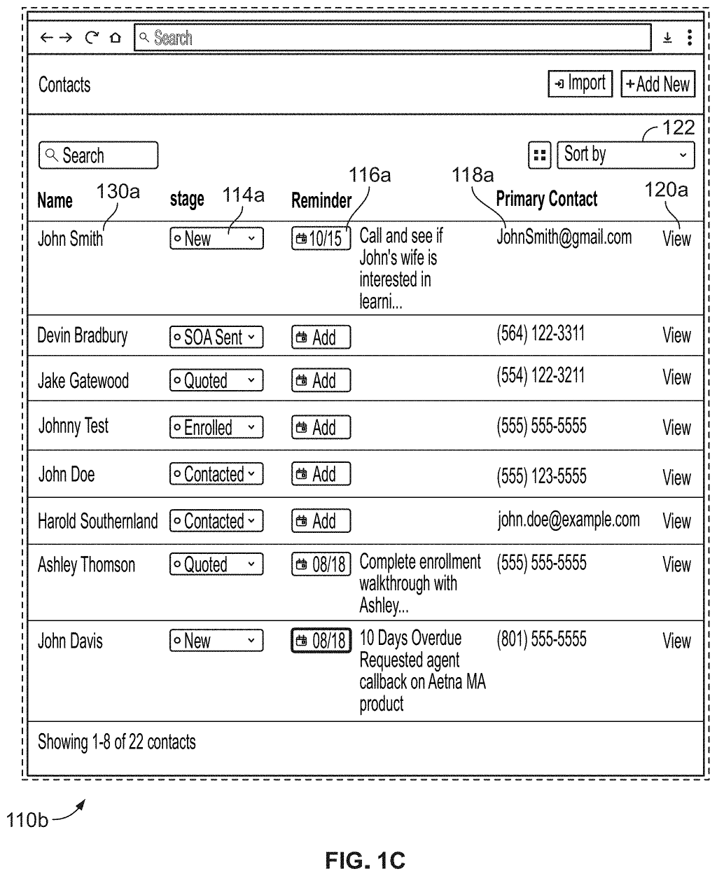

FIG. 1A shows an example computing environment 100 in which a client computing device 102 communicates over the internet (or another network) with a server system 104 and with one or more other computing devices 106. For example, a user's desktop computer 102 communicates with the server system 104 that provides user interfaces for providing beneficial information to an insurance agent, eliciting input from the insurance agent, facilitating communications between the insurance agent's computing device and one or more computing devices 106 of one or more customers, and automatically identifies relevant insurance policy products based on information associated with a specific user. The server system 106 can have access to one or more databases 108 of information. The server system 106 can, for example, store customer information in the database 108 and retrieve the customer information based on requests received from the client computing device 106. The server system 104 can automatically update information in the database 108 based on detected interactions of the agent and/or the customer with their respective computing devices and based on communications between the computing device 102 of the agent and one or more computing devices 106 of the customer.

In the example shown in FIG. 1A, the client computing device 102 shows a user interface 110 displaying a number of customer listings for an insurance agent. The customer listings are shown in a card view in this example. The user interface can allow the agent to switch to a list view. Each customer card displayed in the user interface includes information on the customer including the customers first and last name, current status, contact info (such as phone number and/or email address) and a date indicating when the agent should next follow up with the customer. The agent can select a user selectable edit control displayed along with each card to edit information about each customer. The agent can select a particular customer card to cause the system to display additional detailed information for the selected customer including address, customer preferences, scope of appointment information for the client, insurance products or other products that the customer is interested in, a profile picture for the customer, and the information included in the customer card display.

FIG. 1B shows a user interface 110a representing a version of the user interface 110 of FIG. 1A. The user interface 110a can, for example, be displayed on the computing device 102. For example, the computing device 102 can receive information from the server system 104 over the internet or another network. A browser executing on the computing device 102 then can, for example, render the information received from the server system 104 to provide the user interface 110a. As with the user interface 110, the user interface 110a shows a card view of a list of various contacts for a given insurance agent.

Still referring to FIG. 1B, a first contact card 112a displayed as part of the user interface 110a includes information for a customer (or potential customer) named “John Smith.” In the card view of user interface 110a, the contact card 112a displays information for John Smith including a stage or status 114a of “new,” a next reminder date 116a of October 15^{th} and a preferred primary contact method 118a for the identified contact. In this example, the status 114a of “new” indicates that John Smith is a new contact that the agent has not yet contacted. For example, the agent may have just added the information to John Smith to the system. The next reminder date 116a indicates that the next reminder for this contact is scheduled for October 15^{th}. In some implementations, the displayed next reminder date 116a is a user selectable control. The agent can select the next reminder date 116a to perform one or more actions related to reminders for the client. For example, selection of the next reminder date 116a can cause a pop-up box to be displayed, or a new user interface to be displayed, that allows the agent to change the reminder date, add additional details to the reminder date, delete the reminder date (e.g., because the agent has completed a task associated with the reminder), or add additional reminder dates (e.g., for multiple additional tasks that need to be completed with respect to the contact associated with the contact card 112a).

For some contacts, a reminder may not have been set. For example, a contact card 112b for a contact “Devin Bradbury” does not yet have any reminders set. The agent can select a control 116b to add one or more reminders for the contact represented by the contact card 112b. In one example, the agent can select the next control 116b to add a new reminder for a date prior to expiration of the customer's current coverage plan to contact the customer to discuss policy renewal or policy updating. As another example, the agent can set a reminder for a date (such as two weeks out) to follow up with a customer regarding a sent electronic SOA form that has not yet been signed/returned. The reminder can be automatically populated with information about the customer such as the customer's name and primary contact method 118b. The agent can include notes in a new reminder (or add notes to an existing reminder) to help the agent remember what the reminder is for or what actions should be taken on the reminder date. The system can automatically provide pop-ups or other notifications (e.g., emails, SMS messages, etc.) to the agent to alert the agent when the date for a follow up reminder occurs. These pop-ups or other notifications can be provided on the computing device 102 as well as additional computing devices used by the agent. For example, the server system 104 can communicate with both a laptop computer and a smartphone of the agent to cause both devices to provide notifications for pre-set reminders. In some implementations, the customer cards displayed in FIGS. 1 and 1A can be displayed in a different color (e.g., green, or orange) when a reminder for that customer is approaching (e.g., within three days) or on the date of a reminder for the customer. In some implementations, one color means that the reminder date is approaching while a different color is used to indicate that the reminder date has been reached. In some implementations, rather than or in addition to changing a color of some or all of the a contact card to indicate an approaching reminder, the system can display one or more icons to indicate upcoming reminder dates. For example, different icons (or colors) can be used to indicate different types of reminders (e.g., call contact re SOA, send SOA, meeting re policy options, etc., follow-up meetings, etc.).

In some cases, when the system notifies the agent of a set reminder, the system will include additional information along with the reminder. This additional information can include the customer name, the current status for the customer (e.g., electronic SOA form sent but not signed), notes made by the agent with respect to the customer, and other relevant information. In some cases, the additional information can include indications of selections made by the customer in the SOA. For example, if the reminder if a reminder that the agent has an in-person or tele-appointment with the customer to discuss insurance policy product options for the customer, the system includes an indication of the selections made by the customer in the SOA along with the reminder for the appointment (e.g., displayed as a desktop notification, mobile app notification, email, text message, etc.) so that the agent can be better prepared to discuss the selected options for the customer while also complying with regulatory requirements by avoiding discussing insurance policy product types that were not selected by the user in the SOA.

Still referring to FIG. 1B, the preferred primary contact method 118a for the contact card 112a indicates an email address for the contact John Smith which indicates that, as far as current information indicates, John Smith prefers to be contacted at the identified email address. In some implementations, the agent can select the contact card 112a to cause additional information for the contact to be displayed, which can include additional contact methods (e.g., additional email addresses, one or more phone numbers, a mailing address, etc.) for the contact associated with contact card 112a. The agent can then select a different contact method as a preferred contact method for the contact (e.g., based on updated information from further interactions with the contact). In some implementations, when the primary contact identified by the preferred primary contact method 118a is a phone number, the contact card can further include an indication of if the contact prefers text or voice communication as the preferred contact method using the identified phone number.

In some implementations, the status 114a is a selectable control that the agent can select to manually change the stage or status for the contact. For example, selection of the status 114a displayed as part of contact card 112a (or a status 114b associated with contact card 112b) can cause the user interface 110a to display a dropdown menu that allows the agent to select a status for the associated contact. In some implementations, the computing system will also automatically update the status 114a of the contact based on information or communications sent to the contact by the agent or received from the contact by the agent. In some cases, the status 114a is automatically updated based on other information provided by the agent or based on actions performed by the agent.

The status field 114a can be populated with a current engagement status for the customer. Example statuses (or stages) for each customer can include new (e.g., for newly added customers), contacted (agent has contacted the customer but the customer has not yet signed an electronic scope of appointment form), electronic SOA form sent, electronic SOA form signed, quoted (e.g., one or more insurance product plan quotes sent to customer), applied (e.g., customer has applied for an insurance product plan or other product), enrolled (e.g., customer is currently enrolled in a plan), and lost. For example, the status 114b for contact card 112b shows a status of “SOA sent” while a status 114c for a contact card 112c indicates a status of “Quoted.” The “lost” status can, for example, indicate a customer who has switched to another agent, a customer who has moved out of the country, or a customer who is deceased. The “lost” status designation allows the agent to retain information for the customer while indicating that the customer is not currently an active customer (e.g., the agent does not have to delete the listing for the customer even though the customer is no longer an active customer). As shown in FIG. 1A, each customer listing includes a control that allows the agent to manually change the status for the customer. In some cases, the system will automatically update the status for a customer based on interactions with the system by the agent or by the customer. For example, the system can automatically assign a status of “new” to a newly added customer. As another example, the agent can use the system to automatically generate an email to the customer which the agent can fill out and send. This action can cause the system to automatically change the status for the client to “contacted.”

In some implementations, the user interface 110a allows the user (e.g., the agent) to select each contact card to cause a profile for the user to be displayed (to be described more below). The profile can include additional detailed information for the contact associated with the contact card. In some implementations, instead of or in addition to the entire contact card being user selectable, each contact card contains a specific control that is selectable to cause display of a profile for the contact. For example, the contact card 112a includes a control 120a that can be selected by the agent to cause the computing device 102 to display a profile for the associated contact.

Referring now to FIG. 1C, some embodiments may provide an alternate view of a user interface 110b for viewing contacts for the agent. Specifically, user interface 110b shows a list view (rather than the card view of FIG. 1B) for the contacts for the agent. In some implementations, the system can allow the agent to switch between the two views. For example, the user interface 110 or 110a can include a control that, when selected by the agent, causes the user interface to switch from the card view of user interface 110a to the list view of user interface 110b.

As shown in FIG. 1C, each contact listing of the user interface 110b includes similar controls to those included in each of the contact cards displayed in the user interface of 110a of FIG. 1B. For example, the user interface 110b includes a contact listing 130a that includes the stage or status 114a, the next reminder date 116a, the preferred primary contact method 118a, and the control 120a described with respect to the contact card 112a of FIG. 1B. The function of each of these controls is the same as described above and will not be repeated here. In addition to these controls, the list view of user interface 110b includes additional information on each reminder that has been set. For example, next to the preferred primary contact method 118a, the contact listing 130a includes an indication that the reminder is for a follow up call to determine if the contact's wife is interested in learning about additional coverage options.

Both the user interface 110a and the user interface 110b can include a control 122 for sorting the contacts. Each user interface 110a-b can additionally, or alternatively, include one or more controls for filtering the contacts (e.g., such that only contacts having one or more identified traits are displayed). For example, selection of the sorting control 122 (or a filtering control) can cause a dropdown menu to be displayed that allows the agent to sort or filter the customer contact listings according to various selection criteria. This can include sorting or filtering by name, geography, product types of interest, status, follow-up date (e.g., listing customers in order of the next follow up reminder set for that customer), date the contact was added to the system, or any of the other fields for information for the customer or other criteria established by the agent or by the system.

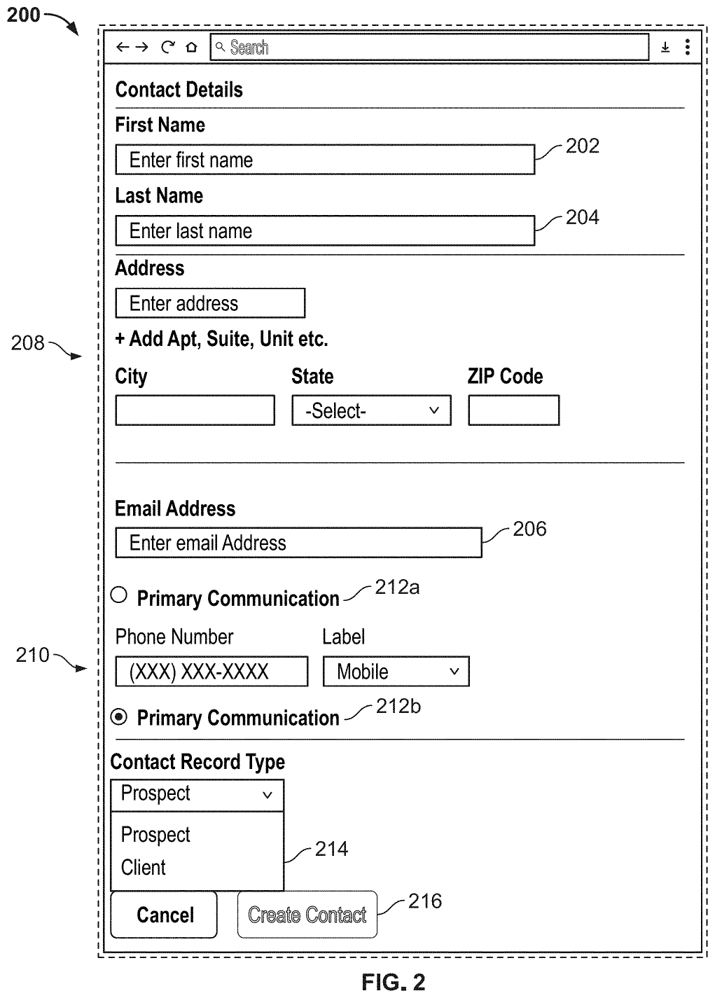

FIG. 2 shows an example user interface 200 that allows an agent to enter information for a new customer manually. The user interface 200 can, for example, be displayed on the computing device 102 of FIG. 1A. For example, the computing device 102 can receive information from the server system 104 over the internet or another network. A browser executing on the computing device 102 then can, for example, render the information received from the server system 104 to provide the user interface 200.

The user interface includes various fields that allow the agent to manually enter information for a new contact, including fields 202, 204 for first and last name, field 206 for email address, fields 208 for mailing address, and fields 210 for specifying a phone number and phone number type (e.g., mobile, home, work, etc.). The agent can also select selectable control 212a or 212b to indicate if the contacts email address or phone number is the primary contact method for the contact. In some implementations, the user interface 200 includes a control for indicating if the user prefers text communication or voice communication via one or more phone numbers. The user interface 200 further includes a user selectable control 214 that causes a dropdown menu to be displayed to allow the agent to specify a contact record type for the contact. In the example shown, the agent can identify the contact record type for the contact as “prospect” or “client.”

In some implementations, the user interface 200 includes one or more controls and/or fields that allow the agent to set a follow up reminder date, enter notes on the newly entered customer, and set the status for the newly added customer (e.g., new, contacted, SOA sent, SOA signed, quoted, Applied, enrolled, etc.). For example, an agent that is new to the system may be entering existing customers as new customer contacts and they may have status other than new (such as SOA signed, applied, enrolled, etc.). Upon entering the information for the new contact, the agent can select a create contact control 216 to cause the system to generate a contact profile for the contact.

In some implementations, the agent can import files containing information for customers to the system. The system can then generate a contact profile for each contact identified in the imported file or files. Examples of such files include a database file stored in computer memory (e.g., either locally or remotely), comma separated list files, or other types of files that include information on customers, such as by designating specific fields and the information to be included in those fields for each customer. Information included in such imported files can include first name, last name, email address, phone number, mailing address, stage/status, contact record type, and client notes. The system can also interact with existing databases (such as Medicare databases) to access information for a customer if the customer has provided confirmation that the agent is allowed to access such information for the customer.

The information stored in association with each contact's respective profile (whether entered manually, imported, or a combination of both) is used by the computing system (e.g., the server system 104) to communicate with third-party computing systems to automatically identify suitable coverage plans for the contact once the contact has signed on as a customer. The server system 104 provides information stored in association with contact profile to automatically populate information fields of the third-party interface (e.g., a website hosted by the third-party servers) to seamlessly allow the agent to review suitable plans for the client.

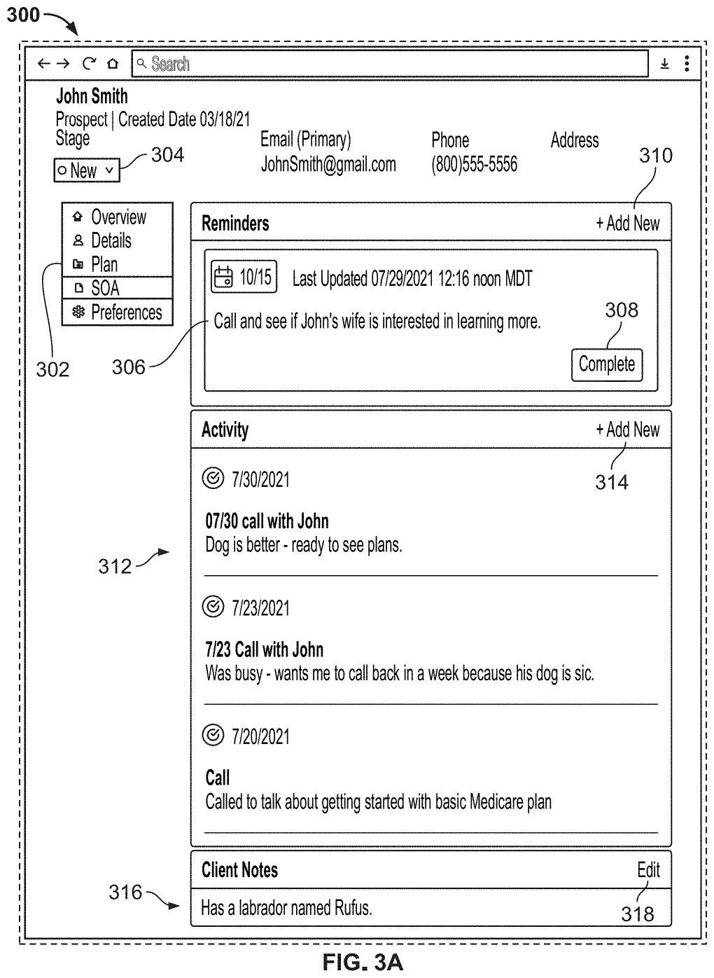

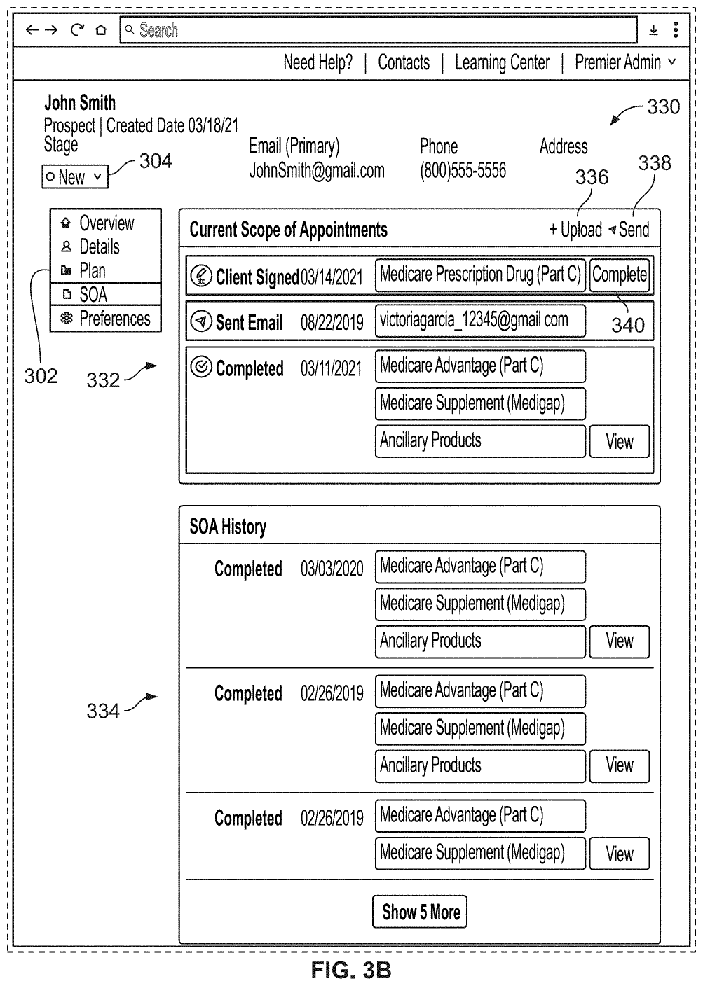

FIG. 3A shows a user interface 300 displaying a profile for a contact. The user interface can be displayed by the system on the computing device 102, for example, in response to the agent selecting he contact card 112a of FIG. 1B, selecting the contact listing 130a of FIG. 1C, or selecting the control 120a shown in FIGS. 1B and 1C. In the example shown, the user interface 300 is displaying an overview tab for the profile for the selected contact. The agent can interact with a control 302 to switch between the overview view shown in FIG. 3A, a details view, a plan view, an SOA view, and a preferences view. The user interface 300 includes contact information for the selected contact at the top, including an email address, a phone number, and a mailing address (if the information is available in the system). The user interface 300 can also include an indication of which listed form of communication is preferred as a primary contact method for the contact.

The user interface 300 includes a control 304 that displays the stage or status for the selected contact. In this example, the selected contact is a new contact (e.g., the agent has not yet reached out to the contact regarding insurance coverage). The agent can select the control 304 to change the stage/status for the selected contact (as previously described). The user interface further includes a reminders field that can include one or more reminders for the agent associated with the selected contact. Each reminder can include a date (or date and time) for the reminder, information on when the reminder was created and/or last updated, and notes related to the reminder. In the example shown, the reminder is for October 15^{th}, was last updated on July 29^{th}, and includes a note that the reminder is to call the contact to determine if the contact's wife is interested in learning more about insurance options. In some implementations, the agent can select the reminder 306 (or a control or icon displayed as part of the reminder 306) to edit the reminder. For example, the agent can select the reminder which can cause the system to display one or more fields or controls that allow the agent to change the date and/or time for the reminder or add additional notes to the reminder. The reminder includes a control 308 that the agent can select when the reminder is complete (e.g., the agent has performed the task indicated by the reminder). In some implementations, when a reminder is changed to a completed status, the reminder is stored in an activity history for the contact or in a list of completed reminders for the contact and is no longer displayed on the overview page. The user interface 300 further includes a control 310 that the agent can select to add a new reminder, including a date and/or time for the reminder and notes on the nature of the reminder.

The user interface 300 includes an activities field 312 showing activities for the selected contact. In this example, the activities are listed from most recent to least recent. In some implementations, the user interface 300 includes a control that allows the agent to order the activities from least recent to most recent. In this example, the activities field 312 indicates that the agent had an introductory call with the contact on July 20^{th}, a follow up call on July 23^{rd} during which the contact was unavailable due to his dog being sick, and a call regarding insurance plans on July 30^{th}. In some implementations, when a reminder is marked as complete (e.g., by selecting control 308), the system automatically converts the reminder to an activity. The agent can then edit the new activity to include additional information on the activity. In some implementations, when the control 308 is selected, the user interface 300 prompts the agent to determine if the agent wishes to enter the completed reminder as an activity in the activity field 312. The user interface 300 further includes a control 314 that allows the agent to enter a new activity, including a header for the activity and additional details on the activity.

The user interface includes a client notes field 316 that displays previously entered notes for the contact. This can allow the agent to enter and later view personal information for the contact to reference in future conversations with the contact. The user interface includes a control 318 that, when selected, allows the agent to edit the client notes field by adding additional notes or editing existing notes on the contact.

FIG. 3B shows a user interface 330 that is displayed in response to the agent selecting an SOA tab/view using the control 302. The user 330 interface includes a current scope of appointments field 332 listing the current SOAs for the contact and the stage of each SOA (e.g., email sent, client signed, SOA completed). The user interface 330 further includes an SOA history field for past SOAs. In some implementations, various listings in the current scope of appointments field 332 and/or SOA history field 334 can include one or more user selectable controls that can be selected to view additional information on the SOA, view the completed or in-progress electronic SOA form, or change the status for a particular SOA (e.g., change to “signed” or “completed”).

In some implementations, the system automatically adds additional listings to the current scope of appointments field 332 in response to detecting interactions between the agent and the system, in response to communications from the agent to the contact, in response to communications received by the agent from the contact, in response to detecting interaction between the contact and/or the agent with an electronic SOA form, or in response to other detected activity. For example, the system can detect when the agent has sent an electronic SOA form to a client. The system can pull the relevant information from the communication (e.g., whom the SOA was sent to, the method of communication used, date and time sent, other relevant information from the SOA) and generate a listing in the current scope of appointments field 332. Continuing with this example, the system can determine when a client has e-signed a previously sent electronic SOA form and update a listing in the current scope of appointments field 332 or create a new listing in the current scope of appointments field 332 indicating that the client has signed the SOA and also indicating which plan options the client has selected in the signed SOA.

In some implementations, the system will automatically generate reminders (e.g., such as the reminders shown in the reminders field 306 of FIG. 3A) in response to actions performed by the agent or client. For example, when the agent generates and sends a new SOA, the system can automatically generate a reminder to follow up with the client if they have not signed the SOA within two weeks and add this reminder to the profile for the client. As another example, when the system detects that the client has signed the SOA, the system can automatically generate a reminder to follow up with the client to schedule an appointment to discuss insurance options (e.g., either an in-person meeting or tele-appointment). The system can then add the reminder to the client's profile and display it on the user interface 300 of FIG. 3A.

The user interface 330 includes a control 336 that allows the agent to upload SOAs. For example, the client may have physically signed the SOA and returned the signed SOA in the mail. The agent can scan and upload the signed SOA to create a new listing in the current scope of appointments field 332. As another example, the client may have e-signed or physically signed the SOA and emailed a PDF of the signed SOA to the agent. As yet another example, the agent may be new to the system and can use the control 336 to upload a previously executed SOA for the client. The user interface 330 includes a control 338 that, when selected, causes the system to display a user interface that allows the agent to send a new SOA to the client.

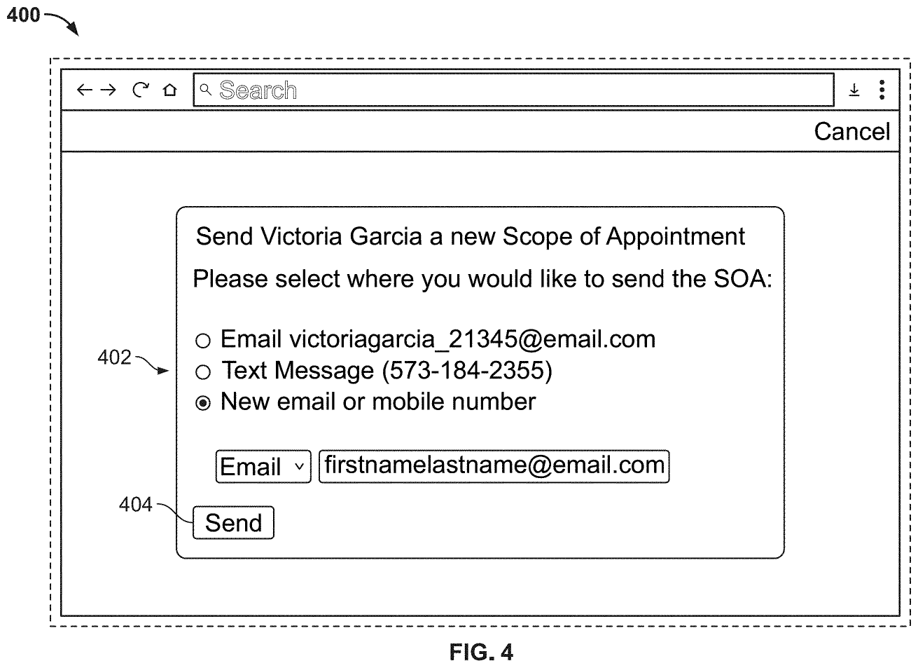

FIG. 4 shows an example user interface 400 that allows an agent to send a new scope of appointment (SOA) form to a client. The user interface 400 can be displayed, for example, in response to selection of the control 338 of FIG. 3B. Upon selection of the control 338, the system generates the user interface 400 with information that is specific to the client. In this example, the user interface 400 indicates that the client's name is Victoria Garcia and includes a control 402 that allows the agent to select from existing contact methods for the client for sending the new SOA or to enter a new contact method for sending the new SOA. In this example, the control 402 allows the agent to choose to email the new SOA (or a link to the SOA) to the client, text a link to the SOA to the client, or enter a new email address or phone number for the client for sending the SOA. After selecting the method for communicating the SOA to the client, the agent can select a control 404 of the user interface 400 to send the SOA to the client.

In some implementations, upon selection of the control 404, the system will automatically generate a communication to the client that includes the electronic SOA form which allows the client to select which insurance product category or categories that they wish to discuss. The SOA can be transmitted by either email or text message based on the selection made by the agent using control 402. For example, a text or email can be sent to the client that includes a link that allows the client to view the SOA, select one or more insurance product categories to discuss, and e-sign the SOA. In some implementations, the text message or email is sent by the client device 102 or by the server system 104. Examples of coverage options that can be selected in an electronic scope of appointment form include stand-alone Medicare Prescription Drug Plans (Part D), Medicare Advantage Plans (Part C) and Cost Plans, Medicare Supplements (Medigap) Products, Dental/Vision/Hearing Products plans, and Hospital Indemnity Products. The system generates an SOA that is specific to the client and populated with the client's information and the agents information and transmits a communication that includes or links to the SOA in response to user selection of the control 404 by the agent. Each SOA interface (such as that shown in FIG. 4a) is specific to a client. In some cases, the system will automatically update the stage/status for the client to “SOA sent” upon generation and transmission of the communication and reflect this updated stage/status on the user's profile and on the client listings user interfaces (e.g., the user interfaces 110, 110a, 110b of FIGS. 1A-1C). In some cases, the system will automatically update the status for the client to “SOA signed” in response to detecting that the client has viewed and electronically signed the SOA.

For example, the text or email communication sent to the client can include a link to the SOA that is stored at the server system 104. The client can select the link to view the SOA in a browser of the client's computing device 106. The client can then make selections for the coverage options that they would like to discuss during the meeting with the agent, e-sign the SOA, and save the updated SOA stored at the server system 104. The server system 104 can detect this update to the SOA and automatically update the stage/status for the client. In response to detecting that the client has signed the SOA the server system 104 can further automatically update the current scope of appointments field 332 of FIG. 3B to reflect that the client has signed the SOA. The server system 104 can also generate one or more reminders to follow up with the client in response to detecting that the client has signed the SOA and populate the reminders field 306 with the one or more reminders.

Returning to FIG. 3B, once the client has signed an SOA, the agent can complete the SOA by also signing the SOA. For example, the agent can select a listing in the current scope of appointments field 332 indicating that the client has signed the SOA to complete the SOA by signing the SOA. For example, the agent can select a control 340 to complete the SOA (e.g., by the agent electronically signing the SOA).

As described above, in some implementations, when the agent sends the new SOA, the system will automatically update the current scope of appointments field 332 to indicate the updated status of the SOA. For example, the user interface 330 can be updated to indicate that the SOA was sent via text message, show the date it was sent, a completion status for the SOA (e.g., “not yet completed”) and a signature status for the SOA (“need client signature”). This information can be automatically populated by the system in response to the agent having selected the send control 404 of FIG. 4. In some implementations, the system provides a personal code that can be provided to the client to allow the client to access the SOA to make selections and electronically sign. After the client has signed, the signature status is updated by the system to “signed” and the system can automatically populate a date signed field. Once the agent has signed, the date agent signed information is automatically populated by the system and the status of the SOA is changed to completed.

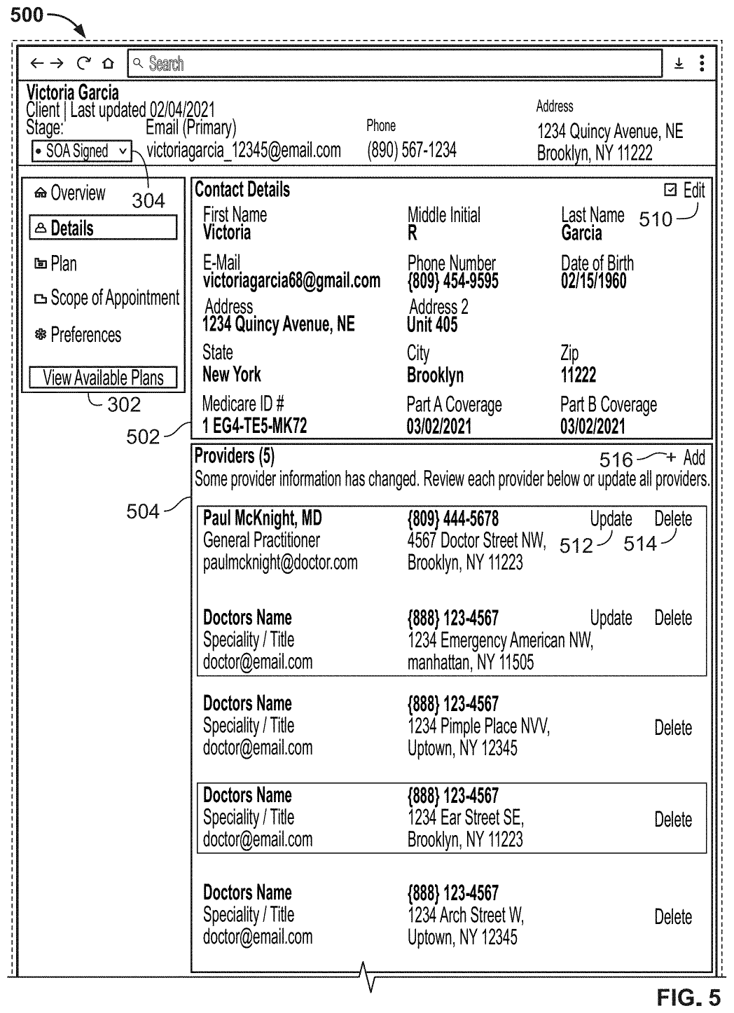

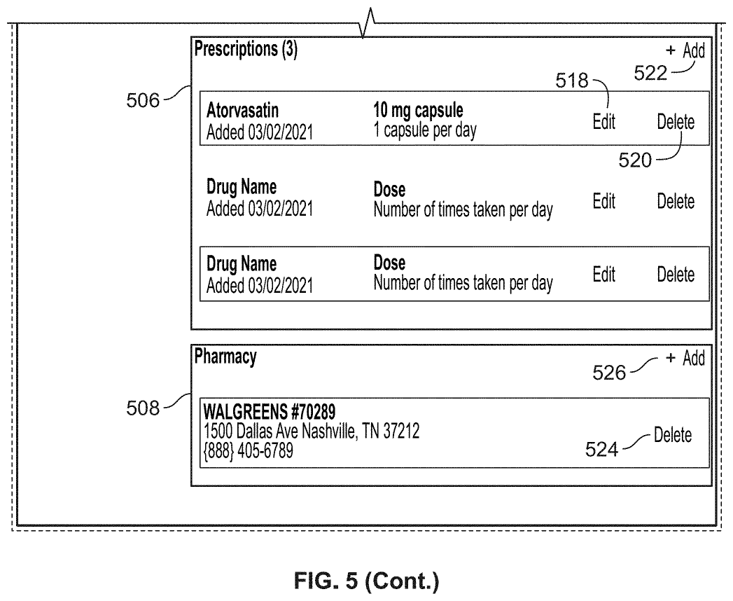

FIG. 5 shows a user interface 500 showing details for the contact “Victoria Garcia.” In this display, the control 304 has been updated to indicate that the current stage/status for the client is “SOA signed.” Furthermore, the control 302 has been updated to include an additional option for viewing available plans. In this view, the agent has selected the details option in the control 302 to cause the system to display the user interface 500. The user interface 500 includes a contact details field 502, a healthcare providers field 504, a prescriptions field 506, and a pharmacies field 508. The contact details field 502 includes details on the contact including full name, email, phone number, date of birth, and mailing address. If the client is currently enrolled in one or more Medicare plans, the contact details field can include information on the Medicare plans (or other insurance plans) for which the contact is currently enrolled has enrolled in the past. For example, in the example shown in FIG. 5, the contact details field 502 shows a Medicare ID number for the contact and shows dates that the contact enrolled in Medicare Part A coverage and Medicare Part B coverage. The user interface 500 provides a user-selectable control 510 that can be selected by the agent to edit details about the contact, including any of the above described details (for example, entering a new start date for a new insurance coverage plan when the contact enrolls in a new plan).

The healthcare providers field 504 lists doctors, healthcare facilities, and other preferred healthcare providers for the client. This can include healthcare providers that the client is currently receiving healthcare from and/or healthcare providers that the client has received healthcare from in the past. Each listing in the healthcare providers field 504 can indicate a name of a healthcare provider or facility and details such as phone number, email address, and physical address. In some implementations, the user interface 500 provides user-selectable controls 512, 514 that allow the agent to update/edit or delete healthcare provider listings for the client. The user interface 500 further includes a control 516 that allows the agent to add additional providers for the client.

The prescriptions field 506 lists various prescriptions that the client is currently taking. In this example, each listing in the prescriptions field 506 includes a name of a predication, the date that the medication was added to the client's profile, the dosage for the medication, and the frequency with which the client is supposed to take the medication. The user interface 500 provides controls 518 and 520 that the agent can select to edit or delete a particular medication listing in the prescriptions field 506. The user interface 500 further includes a control 522 that allows the agent to add additional prescriptions for the client to the listings in the prescriptions field 506.

The pharmacies field 508 includes one or more listings for preferred pharmacies for the client where they prefer to have their prescriptions filled. In some implementations, if no pharmacy has been specified by the agent or the client, the system can automatically populate the pharmacies field 508 with one or more listings for pharmacies located near the address of the client. In some implementations, the user interface 500 provides one or more controls 524 that the agent can select to edit or delete a particular pharmacy listing in the pharmacies field 508. The user interface 500 further includes a control 526 that allows the agent to add additional pharmacies for the client to the listings in the pharmacies field 508.

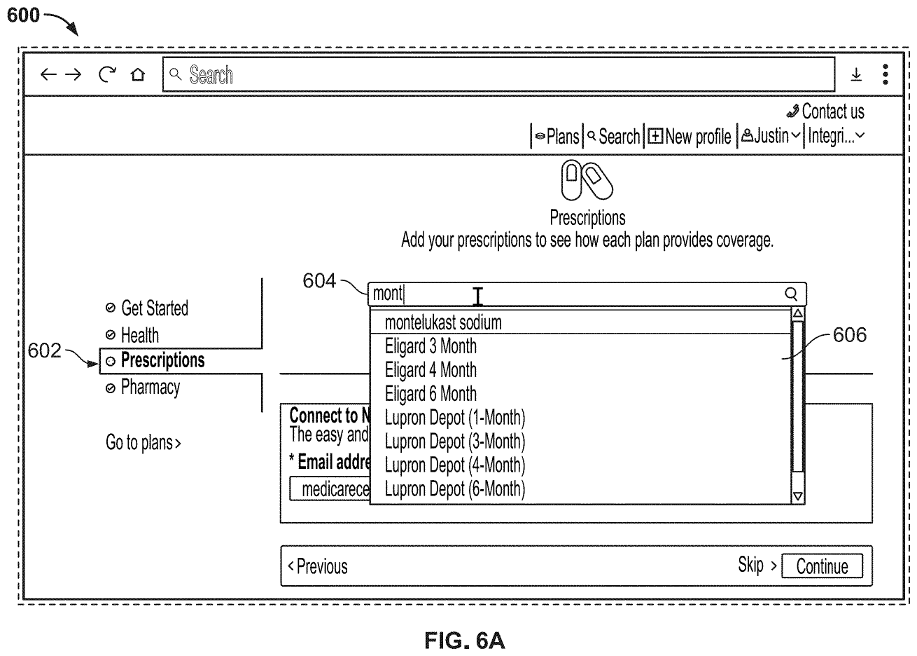

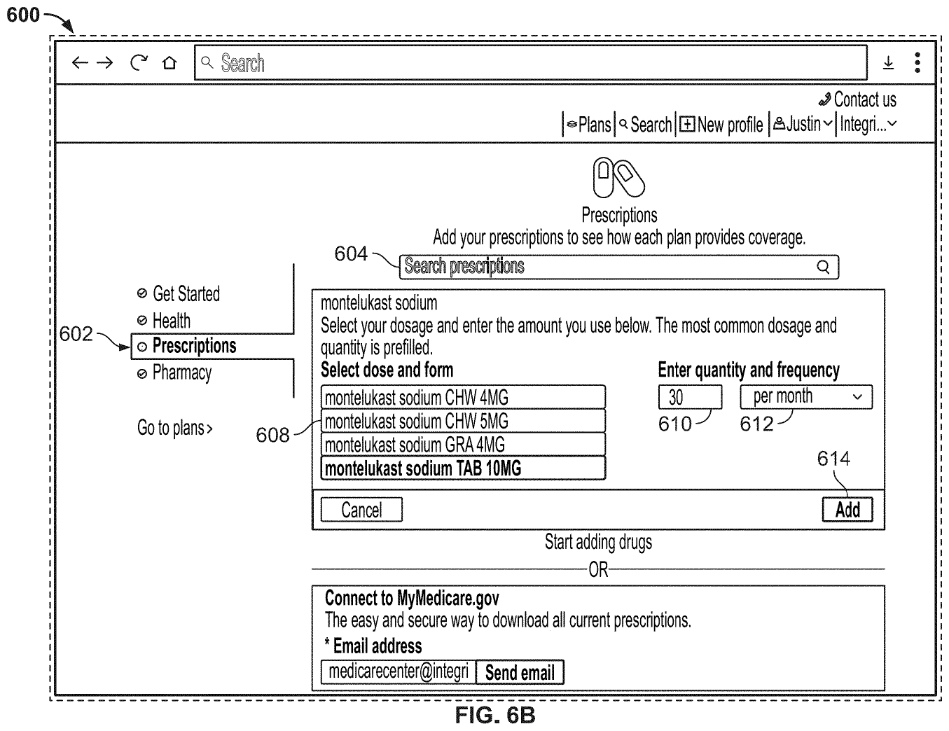

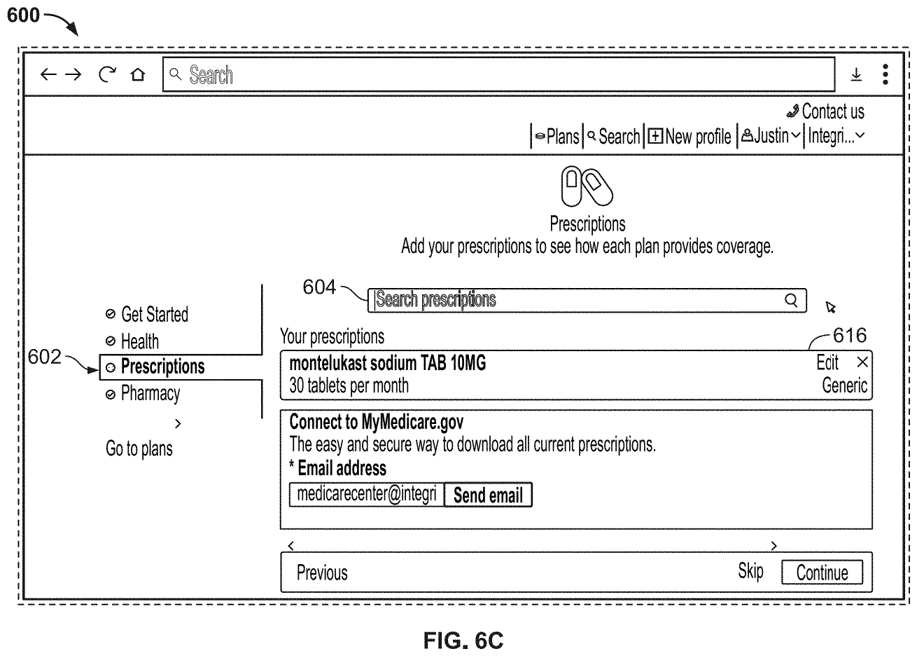

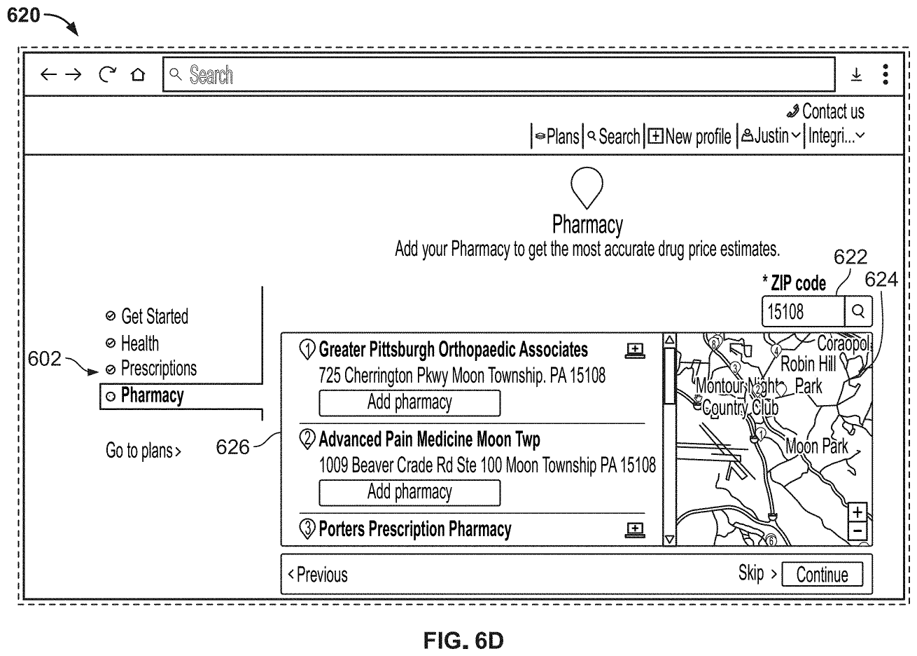

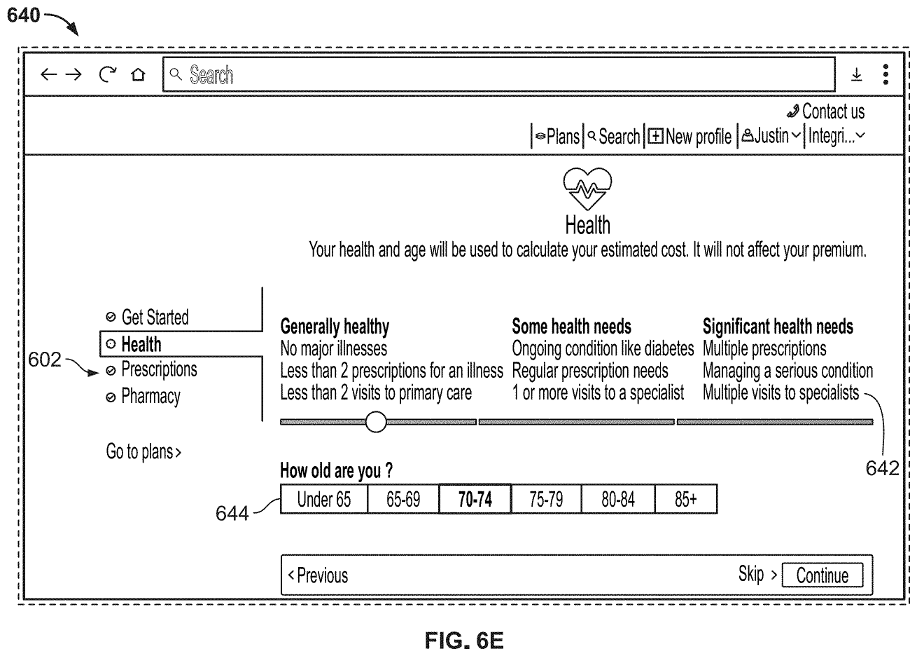

FIG. 6A shows an example user interface 600 that allows the agent (or the client) to enter preference information for the client. User interface 600 includes a control 602 along the left side that guide the agent through preferences entry process by allowing the agent to step through various tabs or pages for entering preference information. In the example shown in FIG. 6A, these tabs include “Get Started,” “Health,” “Prescriptions,” and “Pharmacy.”

In some implementations, the user interface 600 is displayed in response to the agent selecting control 522 of FIG. 5. Selection of the control 522 causes the system to display the user interface 600 which allows the agent to add prescriptions for the client. In some implementations, the process of entering prescription information for the client can be performed by either the agent or the client. The user interface 600 allows the user to enter prescriptions information for the client (e.g., current prescriptions that have been assigned to the client). The user can search for a particular medication/prescription and enter dosage and frequency information for the selected medication/prescription using the user interface 600. This information can allow the system to automatically identify insurance products that provide the best coverage for the combination of prescriptions for the client. In the example shown in FIG. 6A, the user has typed “mont” in a field 604 which causes the user interface 600 to display a dropdown menu 606 showing options for known medications containing the text string “mont.” For example, the server system 104 can access a database such as the database 108 to access information on known prescription drugs and common dosages for those drugs. The user can continue typing in the field 604 to narrow the listing of prescriptions in the dropdown menu 606 or select a prescription displayed in the dropdown menu 606

FIG. 6B shows the user interface 600 FIG. 6A after the user has selected montelukast sodium from the dropdown menu 606. The user interface 600 shown in FIG. 6B includes controls 608 to allow the user to select a particular dosage and form for the selected medication. In the example shown in FIG. 6B, several different dosages (e.g., 4 MG, 5 MG, and 10 MG) and forms (chewable, tablet, etc.) are listed as available selectable options for the selected medication. The user can also enter a quantity for each prescription using a field 610 and how frequently the prescription is refilled using a dropdown menu 612 (or other control(s)). In this example, the quantity is 30 pills prescribed monthly. After selecting the correct medication, dosage size, type, quantity, and frequency, the user can select a control 614 to add the identified prescription to the user's profile. This can cause the system to automatically generate a include a listing for the identified prescription to the prescriptions field 506 of the user interface 500 of FIG. 5. The user interface 600 can also be updated to indicate that the selected prescription has been added to the user's profile. For example, FIG. 6C shows an updated version of the user interface 600 including a prescription listing 616 for montelukast sodium TAB 10MG with number of pills and frequency listed based on the selections and information added by the user using the user interface 600 of FIGS. 6A and 6B. The updated version of the user interface shown in FIG. 6C is displayed, for example, in response to selection of the control 614 of FIG. 6B. The user can continue to use this user interface 600 to add additional prescriptions until all prescriptions for the client are entered. Alternatively or additionally, the agent or client can interact with the system to cause the server system 104 to connect to MyMedicare.gov (or another database containing prescription information) for the customer (if the customer has given permission to do so) to access prescription information for the customer and automatically import the prescription information for the customer into the system and add the imported prescriptions to the client's profile.

FIG. 6D shows an example user interface 620 that is displayed in response to, for example, selection of the “Prescriptions” tab in in the control 602 or the control 526 of FIG. 5. The agent or customer can use the user interface 620 to identify one or more preferred pharmacies for the customer. The user interface 620 can allow the user to search based on geographic location. In some implementations, the system will automatically search for pharmacies within or near the client's zip code or within a certain radius of the client's home or work address. In some implementations, the user can enter the client's zip code (or another preferred zip code indicated by the client) into a field 622 to search for pharmacies in or near the indicated zip code. The user can use a map display 624 to review pharmacies in a particular geographic area. As the user zooms in and out and/or moves the map, pharmacies in the displayed area can be indicated on the map with icons and the displayed pharmacies can be listed alongside the map display 624. The user can further use displayed selectable controls 626 to add one or more preferred pharmacies to the client's list of preferred pharmacies. Upon addition of a pharmacy the system will automatically update the pharmacies field 508 of FIG. 5 to include the added pharmacy.

In some implementations, the system allows the user to add additional information for the client that can be associated with the client's profile and used to identify appropriate coverage plans for the client. For example, FIG. 6E shows an example user interface 640 that is displayed upon selection of the “Health” tab by the agent (or customer) in the control 602. The user interface 640 allows the agent to enter health information and age information for the client based on information received from the client. Alternatively, the client can access the user interface 640 to enter health information. For example, the user can use a control 642 to select a general health level for the client along a sliding scale. The user interface 640 further includes a control 644 that allows the user to select an age range for the client. In some implementations, the age range indication for the client is automatically populated by the system based on the client's birth date.

All or some of the preference information discussed and displayed with respect to FIGS. 6A-6E can be used by the system to automatically identify policies that are a best fit for the customer. The system can then generate a listing of suggested insurance policy products and provide a display of those products to the agent. In some implementations, the computing system (e.g., the server system 104) stores the information discussed and displayed with respect to FIGS. 6A-6E in association with the contact profile for the particular customer. This information on prescriptions, preferred pharmacy's, and other information such as preferred healthcare providers can be used by the computing system when interfacing with third-party computing systems (e.g., server systems for insurance providers) to identify suitable insurance plans for the customer and identify potential insurance plans that meet the customer's needs. For example, the server system 104 can interface with one or more web servers for third-party insurance providers and use the information stored in a customer's contact profile to automatically populate fields of one or more webpages hosted by the web servers to identify relevant insurance policies for the customer. The information stored in the customer's contact profile can also be used to rank identified insurance policies by relevance for the customer or by other factors such as cost based on the customer's unique circumstances (e.g., location, pharmacies, prescriptions, healthcare providers, etc.). Other preference information that can be added for a customer and associated with the customers profile can include preferred contact (e.g., a preferred telephone number or an indication that the customer prefers, text, phone call, email, or physical mail communication).

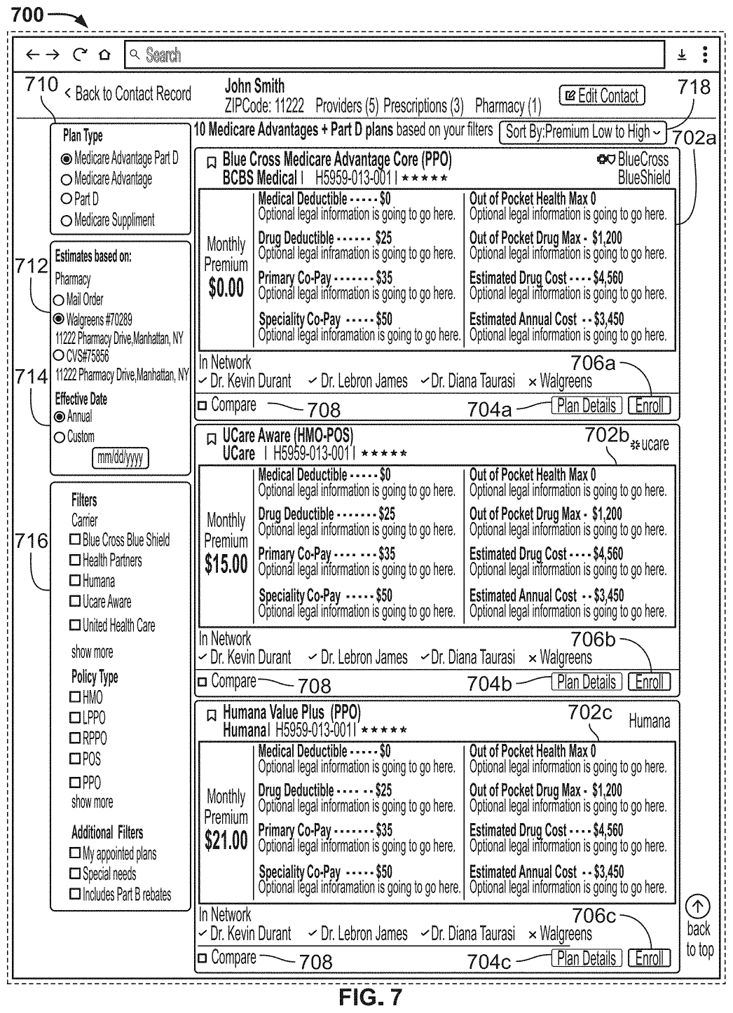

Returning to FIG. 5, the agent can select the “View Available Plans” option from the control 302 to cause the system to identify available insurance plans that are in accordance with the selections that the client selected in the electronic SOA form and based on the preference information discussed above with respect to FIGS. 5 and 6A-E. For example, the system can automatically identify plans that are best for the clients location, indicated prescriptions, preferred pharmacy, and preferred healthcare providers. For example, selection of the “View Available Plans” option from the control 302 can cause the system to generate and display the user interface 700 of FIG. 7. For example, the system can automatically retrieve insurance quotes based on information stored as part of the client's profile (as discussed above), including one or more of the client's location, age, health information, scope of appointment information, preferred pharmacy(s), preferred doctor(s), current prescriptions and other user preferences. For example, the system can use the scope of appointment information for the customer to identify insurance products that match the selected insurance product category or categories included in the customer's electronic SOA form. This information can be combined with user location information, age, and health information to automatically identify and/or generate quotes that are relevant to the user. In some implementations, the server system 104 can automatically identify available insurance plans that are in accordance with the selections that the client selected in the electronic SOA form by interacting with one or more third-party systems for outside insurance providers to gather information on available plans, including cost and coverage details, and generate the overview displays of each plan as shown in FIG. 7. The server system 104 automatically feeds information on the client from the client's profile to computing systems associated with each third-party provider to identify policies relevant for the customer. Additionally, the information provided by the server system 104 to computing systems for such third-party providers is used (either by the server system 104 or the third-party computing systems) to identify specific and/or estimated costs associated with each automatically identified policy. Additionally, this information can be used by one or more of the computing systems to rank the automatically identified insurance policies according to one or more criteria such as relevance to the customer, scope of coverage, cost, etc.

In the displayed example, the user interface includes listings 702a-c for available insurance plans identified by the system. Each listing 702a-c includes overview information about the plan such as deductibles, co-pays, estimated annual costs, and maximum out of pocket expenses. Each listing 702a-c also includes a control 704a-c (respectively) that the agent can select to view additional plan details for each plan. Each listing 702a-c also includes a control 706a-c (respectively) that the agent can select to enroll the client in the identified plan.

In some implementations, the user interface 700 includes one or more controls that allow the agent to flag a particular plan to save for later. For example, the agent may want to identify plans to discuss with the client prior to an in-person meeting or tele-meeting with the client. The agent can then easily recall the previously flagged plans when meeting with the client to discuss options for the client. The user interface 700 further includes a control 708 for each listing 702a-c that can be selected to compare various plans. For example, the agent can select the control 708 for some but not all identified plans and select a compare control (not displayed) to compare the selected plans. This can cause the system to display a user interface that shows details of each selected plan side by side, such as monthly cost, premiums, estimated drug costs, total estimated annual costs, and specific coverage for each plan.

The user interface 700 includes a control 718 that the agent can interact with to sort the identified plans according to a specified criteria. For example, selection of the control 718 can cause the user interface 700 to display a dropdown menu with options for sorting the identified plans. For example, the control 718 can allow the agent to sort the identified plans according to plan premium, total estimated annual cost, Medicare star ratings, plan name, or provider.

The user interface 700 includes a control 710 that allows the agent to switch between various plan types. For example, the client may have indicated in the SOA that they wish to discuss several different Medicare plan types. The system can automatically select plan types from the plan type control 710 based on the selections made in the executed electronic SOA form. Additionally, the agent can select and unselect options in the control 710 to cause the system to search for plans matching the identified plan type(s).

The user interface 700 includes a control 712 that allows the agent to select a preferred pharmacy for identifying plans. This can include pharmacies identified in the client's profile and/or automatically identified as being located near the client's address. The control 712 also provides mail order prescriptions as an option.

The user interface 700 includes a control 714 that allows the agent to select if the effective date for the desired plan should be annual or custom. If a custom date is desired, the agent can enter the date. The user interface also includes a control 716 that allows the agent to apply various filters for filtering out identified plans to allow the agent to focus on the most desirable plans for the client. Filters can include options for selecting one or more insurance carriers, one or more policy types (e.g., HMO, LPPO, RPPO, POS, PPO, etc.), plans that cater to special needs, plans that include Medicare Part B rebates, and other plan specifics.

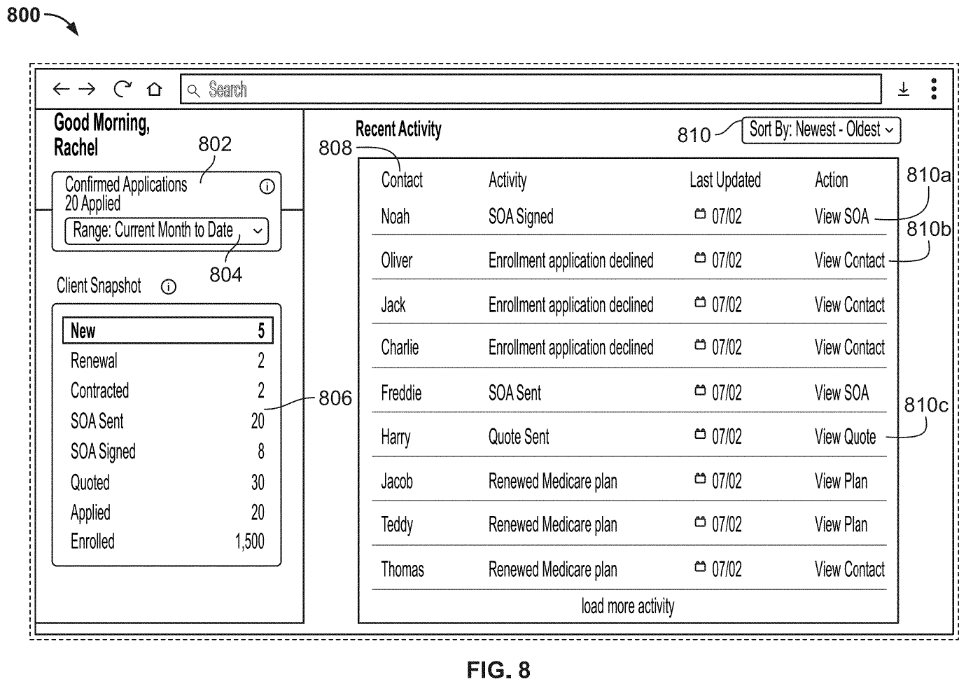

FIG. 8 shows a user interface 800 showing recent activity for an agent. The agent can also use the user interface 800 to navigate to other previously discussed user interfaces. The user interface 800 can be displayed, for example, upon an agent logging into the system and can function as a dashboard for the agent. The user interface 800 includes a field 802 showing the number of confirmed insurance applications for the agent in a specified time period. The user interface 800 includes a control 804 that allows the agent to select a time frame for confirmed applications. For example, the agent can select current month to date, current year to date, or select a past month or year. IN this example, the agent has 20 certified applications in the current month.

The user interface 800 further includes a field 806 that displays the number of clients for the agent broken down by stage/status for the clients. For example, the field 806 shows the number of clients at stages of new, renewal, contracted, SOA sent, SOA signed, quoted applied, and enrolled. In some implementations, the agent can select from among the listings in the field 806 to cause the system to display a list of clients having the indicated stage/status. For example, selection of the SOA sent listing in the field 806 can cause the system to show a card view or list view of clients having a status of SOA sent similar to the user interfaces 110a and 110b shown in FIGS. 1B and 1C.

The user interface 800 includes an activity field 808 that includes listings of recent activities performed by the agent or by clients. The user interface 800 includes a control 810 that allows the agent to sort the activity listings in the activity field 808. For example, the agent can select newest to oldest or oldest to newest. In the displayed example, rather than showing activities related to a single contact/client (such as the activity field 312 displayed as part of a contact profile in the example of FIG. 3A), the user interface shows recent activity related to all clients/contacts for the agent. When the agent performs actions with respect to clients (such as enrolling the client in a plan or sending an SOA to a client), the activity field 808 is automatically updated by the system to include a new listing for the new activity. In some implementations, actions by the client also cause new activity listings to be automatically generated and displayed. For example, when the system detects that the client has signed an SOA, the system can generate a new activity listing in the activity field 808 indicating that the client has signed the SOA.

The activity field 808 includes a number of listings showing recent activity for the agent including SOA sent, SOA signed, enrollment application declined, enrollment application accepted, quote sent, renewed Medicare plan, recently added, and contacted. Each listing includes the name of the client for the activity and the date (or date and time) that the activity occurred. Each listing further includes a control 810 that the agent can select to take a next action for the client. The next suggested action can be automatically identified by the system based on the current status/stage of the client and/or the most recent activity for the client. For example, a first listing in the activity field 808 shows that the SOA has been signed and the control 810a suggests viewing the SOA. The agent can select the control 810a to view the SOA. As further examples, selection of the control 810b will cause the system to display the profile for the associated contact while selection of the control 810c will cause the system to display the quote that was sent to the associated contact. In some implementations, the agent can select the name of any of the displayed contacts in the activity field 808 to cause the system to display the profile for the selected contact.

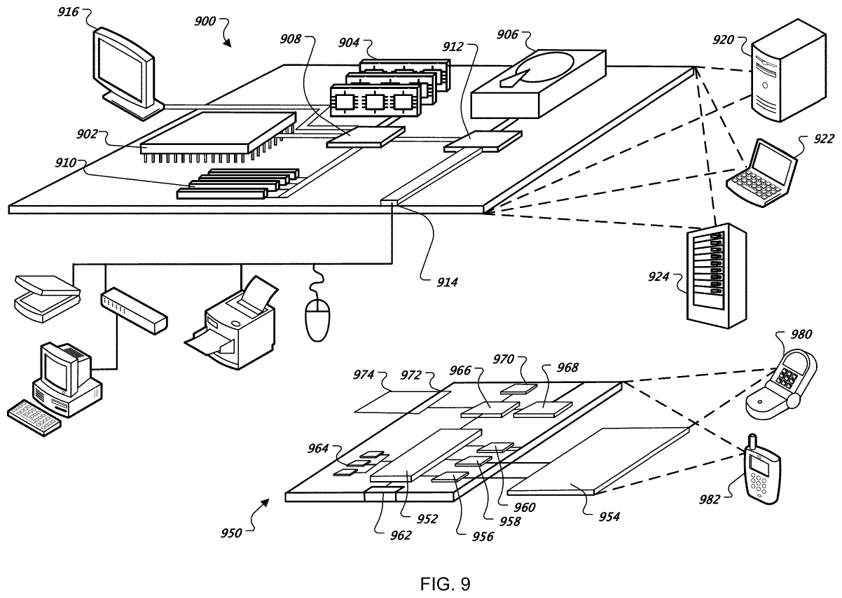

FIG. 9 shows an example of a computing device 900 and an example of a mobile computing device that can be used to implement the techniques described here. The computing device 900 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 900 includes a processor 902, a memory 904, a storage device 906, a high-speed interface 908 connecting to the memory 904 and multiple high-speed expansion ports 910, and a low-speed interface 912 connecting to a low-speed expansion port 914 and the storage device1406. Each of the processor 902, the memory 904, the storage device 906, the high-speed interface 908, the high-speed expansion ports 910, and the low-speed interface 912, are interconnected using various busses, and can be mounted on a common motherboard or in other manners as appropriate. The processor 902 can process instructions for execution within the computing device 900, including instructions stored in the memory 904 or on the storage device 906 to display graphical information for a GUI on an external input/output device, such as a display 916 coupled to the high-speed interface 908. In other implementations, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

The memory 904 stores information within the computing device 900. In some implementations, the memory 904 is a volatile memory unit or units. In some implementations, the memory 904 is a non-volatile memory unit or units. The memory 904 can also be another form of computer-readable medium, such as a magnetic or optical disk.

The storage device 906 is capable of providing mass storage for the computing device 900. In some implementations, the storage device 906 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product can also contain instructions that, when executed, perform one or more methods, such as those described above. The computer program product can also be tangibly embodied in a computer- or machine-readable medium, such as the memory 904, the storage device 906, or memory on the processor 902.

The high-speed interface 908 manages bandwidth-intensive operations for the computing device 900, while the low-speed interface 912 manages lower bandwidth-intensive operations. Such allocation of functions is exemplary only. In some implementations, the high-speed interface 908 is coupled to the memory 904, the display 916 (e.g., through a graphics processor or accelerator), and to the high-speed expansion ports 910, which can accept various expansion cards (not shown). In the implementation, the low-speed interface 912 is coupled to the storage device 906 and the low-speed expansion port 914. The low-speed expansion port 914, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 900 can be implemented in a number of different forms, as shown in the figure. For example, it can be implemented as a standard server 920, or multiple times in a group of such servers. In addition, it can be implemented in a personal computer such as a laptop computer 922. It can also be implemented as part of a rack server system 924. Alternatively, components from the computing device 900 can be combined with other components in a mobile device (not shown), such as a mobile computing device 950. Each of such devices can contain one or more of the computing device 900 and the mobile computing device 950, and an entire system can be made up of multiple computing devices communicating with each other.

The mobile computing device 950 includes a processor 952, a memory 964, an input/output device such as a display 954, a communication interface 966, and a transceiver 968, among other components. The mobile computing device 950 can also be provided with a storage device, such as a micro-drive or other device, to provide additional storage. Each of the processor 952, the memory 964, the display 954, the communication interface 966, and the transceiver 968, are interconnected using various buses, and several of the components can be mounted on a common motherboard or in other manners as appropriate.

The processor 952 can execute instructions within the mobile computing device 950, including instructions stored in the memory 964. The processor 952 can be implemented as a chipset of chips that include separate and multiple analog and digital processors. The processor 952 can provide, for example, for coordination of the other components of the mobile computing device 950, such as control of user interfaces, applications run by the mobile computing device 950, and wireless communication by the mobile computing device 950.

The processor 952 can communicate with a user through a control interface 958 and a display interface 956 coupled to the display 954. The display 954 can be, for example, a TFT (Thin-Film-Transistor Liquid Crystal Display) display or an OLED (Organic Light Emitting Diode) display, or other appropriate display technology. The display interface 956 can comprise appropriate circuitry for driving the display 954 to present graphical and other information to a user. The control interface 958 can receive commands from a user and convert them for submission to the processor 952. In addition, an external interface 962 can provide communication with the processor 952, so as to enable near area communication of the mobile computing device 950 with other devices. The external interface 962 can provide, for example, for wired communication in some implementations, or for wireless communication in other implementations, and multiple interfaces can also be used.

The memory 964 stores information within the mobile computing device 950. The memory 964 can be implemented as one or more of a computer-readable medium or media, a volatile memory unit or units, or a non-volatile memory unit or units. An expansion memory 974 can also be provided and connected to the mobile computing device 950 through an expansion interface 972, which can include, for example, a SIMM (Single In Line Memory Module) card interface. The expansion memory 974 can provide extra storage space for the mobile computing device 950, or can also store applications or other information for the mobile computing device 950. Specifically, the expansion memory 974 can include instructions to carry out or supplement the processes described above, and can include secure information also. Thus, for example, the expansion memory 974 can be provide as a security module for the mobile computing device 950, and can be programmed with instructions that permit secure use of the mobile computing device 950. In addition, secure applications can be provided via the SIMM cards, along with additional information, such as placing identifying information on the SIMM card in a non-hackable manner.

The memory can include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 964, the expansion memory 974, or memory on the processor 952. In some implementations, the computer program product can be received in a propagated signal, for example, over the transceiver 968 or the external interface 962.

The mobile computing device 950 can communicate wirelessly through the communication interface 966, which can include digital signal processing circuitry where necessary. The communication interface 966 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 968 using a radio-frequency. In addition, short-range communication can occur, such as using a Bluetooth, WiFi, or other such transceiver (not shown). In addition, a GPS (Global Positioning System) receiver module 970 can provide additional navigation- and location-related wireless data to the mobile computing device 950, which can be used as appropriate by applications running on the mobile computing device 950.

The mobile computing device 950 can also communicate audibly using an audio codec 960, which can receive spoken information from a user and convert it to usable digital information. The audio codec 960 can likewise generate audible sound for a user, such as through a speaker, e.g., in a handset of the mobile computing device 950. Such sound can include sound from voice telephone calls, can include recorded sound (e.g., voice messages, music files, etc.) and can also include sound generated by applications operating on the mobile computing device 950.

The mobile computing device 950 can be implemented in a number of different forms, as shown in the figure. For example, it can be implemented as a cellular telephone 980. It can also be implemented as part of a smart-phone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a LCD (liquid crystal display) display screen for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the disclosed technology or of what may be claimed, but rather as descriptions of features that may be specific to particular embodiments of particular disclosed technologies. Certain features that are described in this specification in the context of separate embodiments can also be implemented in combination in a single embodiment in part or in whole. Conversely, various features that are described in the context of a single embodiment can also be implemented in multiple embodiments separately or in any suitable subcombination. Moreover, although features may be described herein as acting in certain combinations and/or initially claimed as such, one or more features from a claimed combination can in some cases be excised from the combination, and the claimed combination may be directed to a subcombination or variation of a subcombination. Similarly, while operations may be described in a particular order, this should not be understood as requiring that such operations be performed in the particular order or in sequential order, or that all operations be performed, to achieve desirable results. Particular embodiments of the subject matter have been described. Other embodiments are within the scope of the following claims.

In various implementations, operations that are performed “in response to” or “as a consequence of” another operation (e.g., a determination or an identification) are not performed if the prior operation is unsuccessful (e.g., if the determination was not performed). Operations that are performed “automatically” are operations that are performed without user intervention (e.g., intervening user input). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

“Determining” by a computing system can include the computing system requesting that another device perform the determination and supply the results to the computing system. Moreover, “displaying” or “presenting” by a computing system can include the computing system sending data for causing another device to display or present the referenced information.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Further to the descriptions above, a user may be provided with controls allowing the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

What is claimed is:

1. A computer-implemented method for providing improved facilitation of insurance enrollment, the method comprising:
receiving, by a computing system, information for an insurance product customer, the information including a preferred contact method for the insurance product customer;
generating, by the computing system, a client profile for the insurance product customer;
setting a status for the client profile and associating the status with the client profile;
transmitting, by the computing system over a network to a first remote computing device, client profile user interface information that, when rendered by the first remote computing device causes the first remote computing device to display a first user interface, the first user interface including: (i) an indication of the preferred contact method for the insurance product customer; (ii) a first user-selectable control for setting one or more reminders in association with the insurance product customer; and (iii) a second user-selectable control that, when selected, causes the first remote computing device to display information related to an electronic scope of appointment form for the insurance product customer;
receiving, by the computing system from the first remote computing device, an indication that a user of the first remote computing device has provided user input indicating an intention to generate and transmit the electronic scope of appointment form for the insurance product customer;
in response to receiving the indication that the user of the first remote computing device has provided the user input indicating an intention to generate and transmit the electronic scope of appointment form for the insurance product customer, transmitting, by the computing system over the network to the first remote computing device, second user interface information that, when rendered by the first remote computing device causes the first remote computing device to display a second user interface, the second user interface including: (i) a third user-selectable control that allows the user to select a contact method transmitting the electronic scope of appointment form to the insurance product customer; and (ii) a fourth user-selectable control for initiating generation and transmission of the electronic scope of appointment form for the insurance product customer;
receiving, by the computing system from the first remote computing device, an indication of a contact method indicated by the third user-selectable control and an indication that the user of the first remote computing device has selected the fourth user-selectable control;
in response to receiving the indication that the user of the first remote computing device has selected the fourth user-selectable control: (i) generating, by the computing system, the electronic scope of appointment form for the insurance product customer including automatically populating the electronic scope of appointment form with a name of the insurance product customer; and
(ii) transmitting, by the computing system, a communication to a second remote computing device; wherein the electronic scope of appointment form includes a plurality of coverage options selectable by the insurance product customer, the communication to the second remote computing device includes a link to the electronic scope of appointment form, and the communication is transmitted to the contact method indicated by the third user-selectable control;
in response to transmitting the communication, updating, by the computing system, the status for the client profile to a scope of appointment form sent status;
receiving, by the computing system, an indication that the insurance product customer has selected one or more of the plurality of coverage options included in the electronic scope of appointment form and an indication that the insurance product customer has electronically signed the electronic scope of appointment form;
in response to receiving the indication that the insurance product customer has signed the electronic scope of appointment form, updating, by the computing system, the status for the client profile to a scope of appointment form signed status; and
transmitting, by the computing system over the network to the first remote computing device, third user interface information that, when rendered by the first remote computing device causes the first remote computing device to display a third user interface, the third user interface including the updated status for the client profile indicating the scope of appointment form signed status for the client profile.

2. The method of claim 1, further comprising:
prior to receiving the indication that the insurance product customer has electronically signed the electronic scope of appointment form, transmitting, by the computing system over the network to the first remote computing device, fourth user interface information that, when rendered by the first remote computing device causes the first remote computing device to display a fourth user interface, the fourth user interface including the updated status for the client profile indicating the scope of appointment form signed sent for the client profile.

3. The method of claim 2, further comprising:
in response to transmitting the communication, automatically generating, by the computing system, a reminder for the insurance product customer and associating the reminder with the client profile, the reminder including a date and an indication of an action to be performed on or before the date.

4. The method of claim 1, further comprising:
in response to receiving the indication that the insurance product customer has signed the electronic scope of appointment form, automatically generating, by the computing system, a reminder for the insurance product customer and associating the reminder with the client profile, the reminder including a date and an indication of an action to be performed on or before the date.

5. The method of claim 1, further comprising:
receiving, by the computing device, an indication that the user of the first remote computing device has selected the first user-selectable control;
in response to receiving the indication that the user of the first remote computing device has selected the first user-selectable control, transmitting, by the computing system over the network to the first remote computing device, fourth user interface information that, when rendered by the first remote computing device causes the first remote computing device to display a fourth user interface, the fourth user interface including one or more controls that allow the user of the first remote computing device to enter a date and an action to performed on the date;
generating a reminder that includes the date and the action to performed on the date and associating the reminder with the client profile.

6. The method of claim 1, wherein the first user interface further includes an activity listing including a plurality of activities associated with the insurance product customer, wherein the activity listing includes at least one activity that was automatically generated by the computing system and associated with the client profile.

7. The method of claim 6, further comprising:
transmitting, by the computing system over the network to the first remote computing device, fourth user interface information that, when rendered by the first remote computing device causes the first remote computing device to display a fourth user interface, the fourth user interface including a scope of appointment activity history, the scope of appointment activity history including a listing of activities related to one or more electronic scope of appointment forms for the insurance product customer, the scope of appointment activity history being distinct from the activity listing.

8. A computing system for determining quality of item listings in an online retail environment, the computing system comprising:
one or more processors; and
one or more computer-readable devices including instructions that, when executed by the one or more processors, cause the computing system to perform operations that include:
receiving, by a computing system, information for an insurance product customer, the information including a preferred contact method for the insurance product customer;
generating, by the computing system, a client profile for the insurance product customer;
setting a status for the client profile and associating the status with the client profile;
transmitting, by the computing system over a network to a first remote computing device, client profile user interface information that, when rendered by the first remote computing device causes the first remote computing device to display a first user interface, the first user interface including: (i) an indication of the preferred contact method for the insurance product customer; (ii) a first user-selectable control for setting one or more reminders in association with the insurance product customer; and (iii) a second user-selectable control that, when selected, causes the first remote computing device to display information related to an electronic scope of appointment form for the insurance product customer;
receiving, by the computing system from the first remote computing device, an indication that a user of the first remote computing device has provided user input indicating an intention to generate and transmit the electronic scope of appointment form for the insurance product customer;
in response to receiving the indication that the user of the first remote computing device has provided the user input indicating an intention to generate and transmit the electronic scope of appointment form for the insurance product customer, transmitting, by the computing system over the network to the first remote computing device, second user interface information that, when rendered by the first remote computing device causes the first remote computing device to display a second user interface, the second user interface including: (i) a third user-selectable control that allows the user to select a contact method transmitting the electronic scope of appointment form to the insurance product customer; and (ii) a fourth user-selectable control for initiating generation and transmission of the electronic scope of appointment form for the insurance product customer;
receiving, by the computing system from the first remote computing device, an indication of a contact method indicated by the third user-selectable control and an indication that the user of the first remote computing device has selected the fourth user-selectable control;
in response to receiving the indication that the user of the first remote computing device has selected the fourth user-selectable control: (i) generating, by the computing system, the electronic scope of appointment form for the insurance product customer including automatically populating the electronic scope of appointment form with a name of the insurance product customer; and (ii) transmitting, by the computing system, a communication to a second remote computing device; wherein the electronic scope of appointment form includes a plurality of coverage options selectable by the insurance product customer, the communication to the second remote computing device includes a link to the electronic scope of appointment form, and the communication is transmitted to the contact method indicated by the third user-selectable control;
in response to transmitting the communication, updating, by the computing system, the status for the client profile to a scope of appointment form sent status;
receiving, by the computing system, an indication that the insurance product customer has selected one or more of the plurality of coverage options included in the electronic scope of appointment form and an indication that the insurance product customer has electronically signed the electronic scope of appointment form;
in response to receiving the indication that the insurance product customer has signed the electronic scope of appointment form, updating, by the computing system, the status for the client profile to a scope of appointment form signed status; and
transmitting, by the computing system over the network to the first remote computing device, third user interface information that, when rendered by the first remote computing device causes the first remote computing device to display a third user interface, the third user interface including the updated status for the client profile indicating the scope of appointment form signed status for the client profile.

9. The computing system of claim 8, the operations further comprising:
prior to receiving the indication that the insurance product customer has electronically signed the electronic scope of appointment form, transmitting, by the computing system over the network to the first remote computing device, fourth user interface information that, when rendered by the first remote computing device causes the first remote computing device to display a fourth user interface, the fourth user interface including the updated status for the client profile indicating the scope of appointment form signed sent for the client profile.

10. The computing system of claim 8, the operations further comprising:
in response to transmitting the communication, automatically generating, by the computing system, a reminder for the insurance product customer and associating the reminder with the client profile, the reminder including a date and an indication of an action to be performed on or before the date.

11. The computing system of claim 8, the operations further comprising:
in response to receiving the indication that the insurance product customer has signed the electronic scope of appointment form, automatically generating, by the computing system, a reminder for the insurance product customer and associating the reminder with the client profile, the reminder including a date and an indication of an action to be performed on or before the date.

12. The computing system of claim 8, the operations further comprising:
receiving, by the computing device, an indication that the user of the first remote computing device has selected the first user-selectable control;
in response to receiving the indication that the user of the first remote computing device has selected the first user-selectable control, transmitting, by the computing system over the network to the first remote computing device, fourth user interface information that, when rendered by the first remote computing device causes the first remote computing device to display a fourth user interface, the fourth user interface including one or more controls that allow the user of the first remote computing device to enter a date and an action to performed on the date;
generating a reminder that includes the date and the action to performed on the date and associating the reminder with the client profile.

13. The computing system of claim 8, wherein the first user interface further includes an activity listing including a plurality of activities associated with the insurance product customer, wherein the activity listing includes at least one activity that was automatically generated by the computing system and associated with the client profile.

14. The computing system of claim 8, the operations further comprising:
transmitting, by the computing system over the network to the first remote computing device, fourth user interface information that, when rendered by the first remote computing device causes the first remote computing device to display a fourth user interface, the fourth user interface including a scope of appointment activity history, the scope of appointment activity history including a listing of activities related to one or more electronic scope of appointment forms for the insurance product customer, the scope of appointment activity history being distinct from the activity listing.

15. A computer storage medium encoded with a computer program, the program comprising instructions that when executed by data processing apparatus cause the data processing apparatus to perform operations comprising:
receiving, by a computing system, information for an insurance product customer, the information including a preferred contact method for the insurance product customer;
generating, by the computing system, a client profile for the insurance product customer;
setting a status for the client profile and associating the status with the client profile;
transmitting, by the computing system over a network to a first remote computing device, client profile user interface information that, when rendered by the first remote computing device causes the first remote computing device to display a first user interface, the first user interface including: (i) an indication of the preferred contact method for the insurance product customer; (ii) a first user-selectable control for setting one or more reminders in association with the insurance product customer; and (iii) a second user-selectable control that, when selected, causes the first remote computing device to display information related to an electronic scope of appointment form for the insurance product customer;
receiving, by the computing system from the first remote computing device, an indication that a user of the first remote computing device has provided user input indicating an intention to generate and transmit the electronic scope of appointment form for the insurance product customer;
in response to receiving the indication that the user of the first remote computing device has provided the user input indicating an intention to generate and transmit the electronic scope of appointment form for the insurance product customer, transmitting, by the computing system over the network to the first remote computing device, second user interface information that, when rendered by the first remote computing device causes the first remote computing device to display a second user interface, the second user interface including: (i) a third user-selectable control that allows the user to select a contact method transmitting the electronic scope of appointment form to the insurance product customer; and (ii) a fourth user-selectable control for initiating generation and transmission of the electronic scope of appointment form for the insurance product customer;
receiving, by the computing system from the first remote computing device, an indication of a contact method indicated by the third user-selectable control and an indication that the user of the first remote computing device has selected the fourth user-selectable control;
in response to receiving the indication that the user of the first remote computing device has selected the fourth user-selectable control: (i) generating, by the computing system, the electronic scope of appointment form for the insurance product customer including automatically populating the electronic scope of appointment form with a name of the insurance product customer; and (ii) transmitting, by the computing system, a communication to a second remote computing device; wherein the electronic scope of appointment form includes a plurality of coverage options selectable by the insurance product customer, the communication to the second remote computing device includes a link to the electronic scope of appointment form, and the communication is transmitted to the contact method indicated by the third user-selectable control;
in response to transmitting the communication, updating, by the computing system, the status for the client profile to a scope of appointment form sent status;
receiving, by the computing system, an indication that the insurance product customer has selected one or more of the plurality of coverage options included in the electronic scope of appointment form and an indication that the insurance product customer has electronically signed the electronic scope of appointment form;
in response to receiving the indication that the insurance product customer has signed the electronic scope of appointment form, updating, by the computing system, the status for the client profile to a scope of appointment form signed status; and
transmitting, by the computing system over the network to the first remote computing device, third user interface information that, when rendered by the first remote computing device causes the first remote computing device to display a third user interface, the third user interface including the updated status for the client profile indicating the scope of appointment form signed status for the client profile.

16. The computer storage medium of claim 15, the operations further comprising:
prior to receiving the indication that the insurance product customer has electronically signed the electronic scope of appointment form, transmitting, by the computing system over the network to the first remote computing device, fourth user interface information that, when rendered by the first remote computing device causes the first remote computing device to display a fourth user interface, the fourth user interface including the updated status for the client profile indicating the scope of appointment form signed sent for the client profile.

17. The computer storage medium of claim 15, the operations further comprising:
in response to transmitting the communication, automatically generating, by the computing system, a reminder for the insurance product customer and associating the reminder with the client profile, the reminder including a date and an indication of an action to be performed on or before the date.

18. The computer storage medium of claim 15, the operations further comprising:
in response to receiving the indication that the insurance product customer has signed the electronic scope of appointment form, automatically generating, by the computing system, a reminder for the insurance product customer and associating the reminder with the client profile, the reminder including a date and an indication of an action to be performed on or before the date.

19. The computer storage medium of claim 15, the operations further comprising:
receiving, by the computing device, an indication that the user of the first remote computing device has selected the first user-selectable control;
in response to receiving the indication that the user of the first remote computing device has selected the first user-selectable control, transmitting, by the computing system over the network to the first remote computing device, fourth user interface information that, when rendered by the first remote computing device causes the first remote computing device to display a fourth user interface, the fourth user interface including one or more controls that allow the user of the first remote computing device to enter a date and an action to performed on the date;
generating a reminder that includes the date and the action to performed on the date and associating the reminder with the client profile.

20. The computer storage medium of claim 15, wherein the first user interface further includes an activity listing including a plurality of activities associated with the insurance product customer, wherein the activity listing includes at least one activity that was automatically generated by the computing system and associated with the client profile.

21. The computer storage medium of claim 15, the operations further comprising:
transmitting, by the computing system over the network to the first remote computing device, fourth user interface information that, when rendered by the first remote computing device causes the first remote computing device to display a fourth user interface, the fourth user interface including a scope of appointment activity history, the scope of appointment activity history including a listing of activities related to one or more electronic scope of appointment forms for the insurance product customer, the scope of appointment activity history being distinct from the activity listing.

22. A computing device having one or more processors and computer readable memory storing instructions that, when executed by the one or more processors, causes the computing device to:
provide a first user interface containing a listing of a plurality of insurance customer contacts, at least one of the insurance customer contacts being associated with a scheduled reminder;
receive user input selecting one of the plurality of insurance customer contacts;
responsive to receiving the user input selecting the one of the plurality of insurance customer contacts, display profile information for the insurance customer contact;
receive user input indicating an intention of a user to send an electronic scope of appointment form to the selected one of the plurality of insurance customer contacts; and
responsive to receiving the user input indicating the intention of the user to send the electronic scope of appointment form to the selected one of the plurality of insurance customer contacts, initiate generation of the electronic scope of appointment form by a remote computing system such that the electronic scope of appointment form is specific to the selected one of the plurality of insurance customer contacts.

23. A computer-implemented method for providing improved facilitation of insurance enrollment, the method comprising:
generating, by a computing system, an electronic scope of appointment form for an insurance product customer including automatically populating the electronic scope of appointment form with a name of the insurance product customer;
transmitting, by the computing system, a communication to a remote computing device, the communication to the second remote computing device including a link to the electronic scope of appointment form;
receiving, by the computing system, an indication that the insurance product customer has electronically signed the electronic scope of appointment form;
in response to receiving the indication that the insurance product customer has signed the electronic scope of appointment form, updating, by the computing system, a status for the insurance product customer to a scope of appointment form signed status.
